(19) United States
(12) Patent Application Publication
(10) Pub. No.: US 2024/0028945 A1
(43) Pub. Date: Jan. 25, 2024

(54) DATA SLICING FOR INTERNET ASSET ATTRIBUTION

(71) Applicant: Palo Alto Networks, Inc., Santa Clara, CA (US)

(72) Inventors: Elisha Aharon Yadgaran, Menlo Park, CA (US); Pamela Lynn Toman, Campbell, CA (US); Xavier Jacques Mignot, San Francisco, CA (US); Sydney Marie Wong, Berkeley, CA (US); Alejandro Omar Lopez Suarez, San Francisco, CA (US); Christina Papadimitriou, Brooklyn, NY (US); Gregory David Heon, San Francisco, CA (US); Aaron Mark Isaksen, Brooklyn, NY (US); Matthew Stephen Kraning, San Francisco, CA (US)

(21) Appl. No.: 17/814,005

(22) Filed: Jul. 21, 2022

(51) Int. Cl. G06N 20/00

(52) U.S. Cl. CPC G06N 20/00

(57) ABSTRACT

An asset attribution model attributes assets to organizations according to metadata about the assets retrieved by a network scanner and other metadata in association with the assets that is retrieved and stored in a repository. A data slice rules interface applies logical rules to query the repository to retrieve metadata for assets satisfying each logical rule to generate data slices. Each logical rule is constructed so that assets satisfying the rule have attributions to known organizations. The asset attribution model is evaluated for accuracy in predicting known attributed organizations along each data slice. Depending on the resulting accuracies, the asset attribution model either updates its architecture and is retrained or is deployed for asset attribution.

### BACKGROUND

The disclosure generally relates to computing arrangements based on specific computational models (G06N) and to machine learning (e.g., CPC G06N/20).

Data slicing is a technique for improving edge case model performance that is obfuscated when looking at model performance over entire testing sets, subsets of testing sets that are sampled uniformly, and aggregate performance metrics. According to this technique, data slices are identified as subsets of training and testing data where models can exhibit degenerate performance. Models are evaluated and improved specifically along data slices to increase overall performance.

### BRIEF DESCRIPTION OF THE DRAWINGS

Aspects of the disclosure may be better understood by referencing the accompanying drawings.

FIG. 1 is a schematic diagram of example operations for generating data slices from asset attribution data.

FIG. 2 is a schematic diagram of an example system for asset attribution with data slice-augmented features.

FIG. 3 depicts a table of data slice rules and an example iterative data slice rule.

FIG. 4 is a flowchart of example operations for updating an asset attribution model using data slices.

FIG. 5 is a flowchart of example operations for evaluating an asset attribution model on a data slice.

FIG. 6 depicts an example computer system with an Internet asset data lake, an asset attribution model, and a data slice rules interface

### DESCRIPTION

The description that follows includes example systems, methods, techniques, and program flows that embody aspects of the disclosure. However, it is understood that this disclosure may be practiced without these specific details. For instance, this disclosure refers to improving asset attribution models by identifying data slices with known asset/organization attributions where the asset attribution models are underperforming and improving the asset attribution models using features engineered according to the data slices in illustrative examples. Aspects of this disclosure can be instead applied to using data slices for feature engineering for any machine learning model. In other instances, well-known instruction instances, protocols, structures and techniques have not been shown in detail in order not to obfuscate the description.

Overview

Organizations maintaining Internet-facing assets are exposed to security risks as assets proliferate and software/hardware running thereon deprecates. Tracking assets poses a logistical challenge as large amounts of assets are lost in records and separated across technology areas, departments, private networks, etc. In some instances, assets are not even known to be exposed to the Internet. Untracked assets can have open connections to the Internet and significant malware vulnerabilities when these assets have outdated security software and/or are not configured for Internet exposure. Because exposed assets are Internet-facing, network scanners can intelligently probe assets that are likely to be associated with one or more organizations to be secured. Assets can have associated metadata that highly correlates with known organizations, but these assets can be malicious and/or unrelated. Asset attribution models trained on large sets of asset metadata to correctly attribute these assets with known organizations can experience degenerate performance for assets that are highly correlated but unrelated to falsely attributed organizations.

Based on domain-level knowledge, certain types of assets will always be associated with respective organizations. This domain-level knowledge yields hard coded rules that determine slices of asset metadata wherein assets are known to be associated with one or more organizations. The domain-level knowledge comprises characteristics of assets within each data slice that determine these known attributions. The present disclosure is a framework for generating these understood data slices and using them to improve performance of asset attribution models that predict asset/organization attribution. A data slice rules parser generates data slices according to rules that are managed by a domain-level expert at varying scopes. Each rule specifies a logical expression that can be applied to metadata for assets, and data slices are generated by selecting assets to be predicted within each data slice according to the logical expression. An asset attribution model trained on data across asset metadata and organization metadata is evaluated against known organization/asset attributions for each data slice. For data slices where the asset attribution model underperforms, model performance is augmented using preprocessing to engineer features that correspond to the underperforming data slices. The model is then retrained and reevaluated for performance against the underperforming and remaining data slices (as well as for training and testing error across the entire training testing set) prior to deployment. This rules-based framework is flexible and extends to applying business logic to predictive models and identifying model flaws pre-release. Moreover, testing, updating, and retraining asset attribution models on edge-case data slices improves attribution of untracked assets across organizations with possible Internet exposure and reduces false positive attributions possibly associated with malicious attacks.

### Terminology

An “asset” as used herein is a component of a computing environment performing operations on data that may be sensitive to exposure outside of the computing environment. Assets can include hardware, software, cloud instances, virtual machines, registration records, security certificates, networking equipment, databases, repositories, etc.

An “organization” as used herein is an entity that maintains one or more assets with common security risks. For instance, organizations can host private networks and exposure of one public-facing node in the private network can comprise the entire network. Organizations maintain assets across technology types and Internet interfaces such as Voice over Internet Protocol (VoIP) hardware, cloud-based assets, mobile devices, etc. Organizations can comprise a hierarchical structure of sub-organizations such that any sub-organization is exposed to the same or similar common security risk as other sub-organizations.

“Metadata” as used herein refers to data fields, attribute data, and other available/known data for various types of entities including assets and organizations. Metadata can be read from logs, can be queried from URLs, can be queried from databases, etc. Metadata can be stored in association with entities for subsequent use in asset attribution.

A “rule” (alternatively “data slicing rule”) as used herein refers to a logical expression that can be applied to asset metadata to select from or reduce a set of assets to those having asset metadata that satisfies the logical expression. Rules can be represented as logical syntax expressed over metadata fields for assets or can be expressed as queries (e.g., a Structured Query Language (SQL) query) that can be parsed by a corresponding repository to apply the respective rules to return metadata for a set of assets stored in the repository.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Example Illustrations

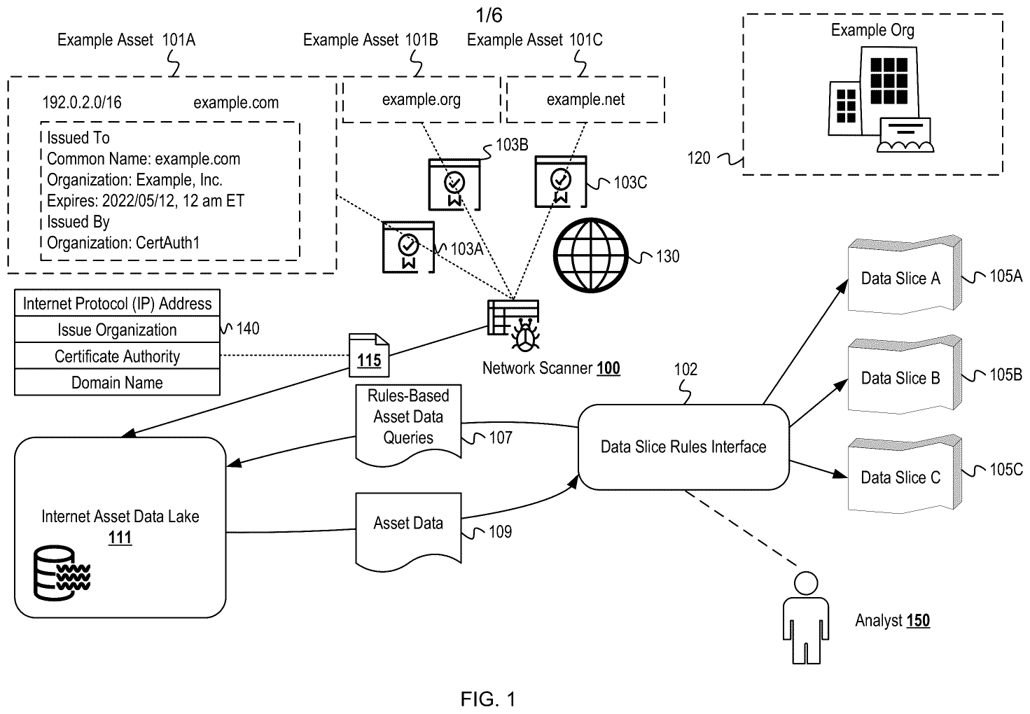

FIG. 1 is a schematic diagram of example operations for generating data slices from asset attribution data. An Internet asset data lake 111 stores logs of data related to assets exposed to the Internet 130 that are identified and probed by network scanner 100. The Internet asset data lake 111 stores large amounts of data that can contain noise/extraneous information with respect to determining asset attributions that map assets to organizations. The data in the Internet asset data lake 111 includes asset metadata, organization metadata, certificates for domain names/Internet Protocol (IP) addresses associated with assets, etc. To select from data stored in the Internet asset data lake 111 and thus generate targeted subsets of assets that relate to known asset attributions, a data slice rules interface 102 queries the Internet asset data lake 111 for data satisfying respective rules and uses the returned data to generate data slices. These data slices are then used to improve performance and gate deployment for asset attribution models based on expected asset attributions for each respective data slice. Asset attribution models are depicted variously herein as predicting asset ownership. These predictions correspond to each asset's likelihood/probability/confidence (these terms are used interchangeably herein) to be attributed to each respective organization. When the likelihoods for assets to be attributed to respective organizations are sufficiently high (e.g., above a threshold), each prediction results in an attribution to the organization corresponding to the highest likelihood indicated in the prediction. In some embodiments, assets are attributed to multiple organizations each having a likelihood over a threshold likelihood in the predictions.

The network scanner 100 scans/probes for devices connected/exposed to the Internet 130 and extracts asset metadata from responses. The network scanner 100 comprises one or more scanning components that scan for available assets and different types/aspects of asset metadata of available assets. For instance, the network scanner 100 can comprise a port scanner (e.g., the Nmap® Security Scanner) that searches for open/closed ports across one or more networks maintained by an organization, and once open ports are identified the network scanner 100 can perform additional probing via other scanning components. The network scanner 100 can track applications/processes running on available assets and can compare identifiers/signatures/etc. with databases of identifiers/signatures/etc. for known malicious applications/processes.

The network scanner 100 can further comprise a Web crawler component that operates according to a crawling policy. The crawling policy maintains a queue of uniform resource locators (URLs) to query (e.g., via Hypertext Transfer Protocol Secure (HTTPS) or HyperText Transfer Protocol (HTTP) requests) and the network scanner 100 sequentially queries each URL popped off of the top of the queue. For instance, the crawling policy can comprise a selection policy for selecting new URLs to queue and a revisit policy to queue previously queried URLs. The selection policy can use metrics such as PageRank, weights for domain names indicating certain known strings, weights for Domain Name System (DNS) root servers/authoritative name servers, etc. to influence ordering of URLs in the queue. The revisit policy can incorporate factors such as malware detected at previously queried URLs, false asset attributions at previously queried URLs, time since querying previously queried URLs, etc. URLs comprising strings that are semantically similar to organization identifiers (e.g., according to a Levenshtein distance) can be prioritized towards the top of the queue. In some embodiments, to avoid malware behavior such as redirection, the network scanner 100 queries same assets on the Internet 130 with different user-profiles (e.g., different user agents, web browsers, etc.), and can repeatedly query dynamic content likely to be malware. The network scanner 100 can additionally scan data sources such as open-source IP address data sets for asset metadata. Any of the components of the network scanner 100 can be off-the-shelf third-party applications or can be custom scanning components designed specifically for asset attribution.

In some embodiments, the network scanner 100 scans one or more network(s) associated with an organization in multiple stages. In a first stage, the network scanner 100 scans ports on the network(s) to determine any assets that are accessible in the network via the scanned ports. In a second stage, the network scanner 100 scans for metadata for the assets determined to have open ports/accessibility over the network(s). Scanning those assets that are accessible to the network(s) helps identify assets that have the most critical security exposure so that, once attributed to the organization with an asset attribution model, the organization can take remedial action to limit security exposure of attributed assets.

The network scanner 100 scans example assets 101A, 101B, and 101C for example asset data 103A, 103B, and 103C, respectively. Example asset 101A corresponds to domain name “example.com” and IP address 192.0.2.0, example asset 101B corresponds to domain name “example.org”, and example asset 101C corresponds to domain name “example.net.” Example asset 101A returns the following certificate in response to a query (e.g., an HTTPS request) from the network scanner 100:
Issued to
Common Name: example.com
Organization: Example Inc.
Expires: 2022/05/12, 12 am ET
Issued By
Organization: CertAuth1
   In this example, we see that example asset 101A has a certificate issued by certificate authority CertAuth1 and is issued to an organization Example, Inc. with domain name example.com. FIG. 1 additionally depicts an example organization 120 labeled “Example Org” that may be associated with any of the example assets 101A, 101B, and 101C. While the example organization 120 shares “example” with domain names of the assets 101A, 101B, and 101C, in some instances these domain names can be maliciously generated to resemble the name of example organization 120 and/or they can be unrelated. In other instances, the example assets 101A, 101B, and 101C may be hosted by example organization 120, however are assigned to a distinct organization using the hosting service (e.g., when the example organization 120 is a cloud service provider that registers IP addresses and then leases/assigns the registered IP addresses to a distinct organization corresponding to one or more of the example assets 101A, 101B, and 101C). An asset attribution model has the potential to incorrectly map example organization 120 to any one of the assets 101A, 101B, and 101C.

The network scanner 100 extracts asset data 115 from responses to asset scans/probes on the Internet 130 which it communicates to the Internet asset data lake 111. The asset data 115 comprises example data fields 140 including an IP address, an issued organization, a certificate authority, and a domain name. These fields are chosen for the purposes of illustration and additional fields identified by the network scanner 100 can be included. For instance, the network scanner 100 can detect any open ports at the example assets 101A, 101B, and 101C and include port numbers and connectivity status in the asset data 115. The network scanner 100 can further include service/process identifiers and (optionally) time stamps indicating services/processes running on assets in the asset data 115. The network scanner 100 can comprise a parsing subcomponent configured to extract fields from responses to queries over the Internet 130 based on known formats for responses. For instance, the network scanner 100 can extract fields in a certificate message returned in response to an HTTPS request, fields in queried URLs, fields in content returned in response to HTTPS requests, as well as any external data fields known for assets being probed. In some instances, the network scanner 100 is configured to selectively parse content returned in response to HTTPS requests based on an importance model (not depicted) that predicts fields/strings likely to be important for asset assignment and/or malware detection. In some embodiments, the network scanner 100 has hardcoded rules for parsing types of content returned from querying the Internet 130.

The Internet asset data lake 111 continuously receives and stores the asset data 115 from the network scanner 100. The Internet asset data lake 111 can receive data from additional sources pertaining to asset attribution and store this data in indexed repositories that can be concisely and efficiently queried. For instance, the Internet asset data lake 111 can store firewall logs for firewalls monitoring traffic from one or more organizations including the example organization 120. These firewall logs can include URLs accessed by the organizations, malicious verdicts, identifiers for users/branches/departments of the organizations, device identifiers for the organizations, etc. The Internet asset data lake 111 can additionally include repositories of asset data for commonly attributed organizations such as cloud service providers, email providers, public sector entities, large/well-known organizations, Internet of Things (IoT) providers, etc. In some embodiments, the network scanner 100 updates its scanning policies according to data for organizations that are being assigned attributes. For instance, URLs present in the Internet asset data lake 111, domain names associated with the organizations, URLs/uniform resource identifiers (URIs) for devices associated with the organizations in the Internet asset data lake, etc. can be greedily queried and re-queried. Greedy crawling policies that prioritize querying assets likely to be associated with organizations enables online tracking of assigned assets (e.g., for malicious activity) and efficient asset attribution.

The data slice rules interface 102 queries the Internet asset data lake 111 with rules-based asset data queries 107, and the Internet asset data lake 111 returns asset data 109 responsive to these queries. The data slice rules interface 102 generates the rules-based asset data queries 107 according to hard coded rules that are iteratively generated and refined by an analyst 150. These hard coded rules isolate slices of asset data from the Internet asset data lake 111 that correspond to known asset attributions, such as example data slice A 105A, example data slice B 105B, and example data slice C 105C. Each rule corresponding to the rules-based asset data queries 107 comprises a logical syntax that represents a logical expression for selecting asset data from the Internet asset data lake 111. For instance, the logical expression can be that country code of asset=US, that trust score >50, that domain name is in list of email provider domain names, any logical combination of the preceding rules, etc. These hard coded rules can be generated by the analyst 150 using a SQL query that applies to data fields for assets in the Internet asset data lake 111 according to logic specified by the SQL query. In some embodiments, the analyst 150 specifies a logical rule to the data slice rules interface 102 (e.g., via a graphical user interface), and the data slice rules interface 102 automatically converts the logical rule to an SQL query.

Each rule indicated in the rules-based asset data queries 107 corresponds to known asset attributions. For instance, the analyst 150 may know that the top-N assets as rated by a confidence score (e.g., as generated by an asset attribution confidence model) should be correctly attributed. The analyst 150 may know that all assets associated with a well-known cloud service provider (e.g., the Amazon Web Services® service, the Google Cloud® service, etc.) should be correctly attributed. In addition, each data slice rule indicates a different set of one or more asset characteristics, although different data slicing rules can have a characteristic in common (e.g., overlapping or intersecting sets of characteristics). The analyst 150 can generate data slices based on false negatives/positives for a deployed asset attribution model. Each data slice comprises data stored in the Internet asset data lake 111 for assets that satisfy the respective rules. Data slices are identified for strata of assets where an asset attribution model should be performing well or is known to be performing poorly (e.g., via identification of false positives/negatives), so that training data and feature generation augmented by the data slices improves model performance. While depicted as a human, the analyst 150 can alternatively comprise a machine learning model, a set of hard coded policies, a separate software package, etc. that can automatically engineer rules for data slices. For instance, a machine learning model can identify data slices for which a deployed asset attribution model is underperforming and can automatically generate rules corresponding to high probability attributions that isolate these data slices.

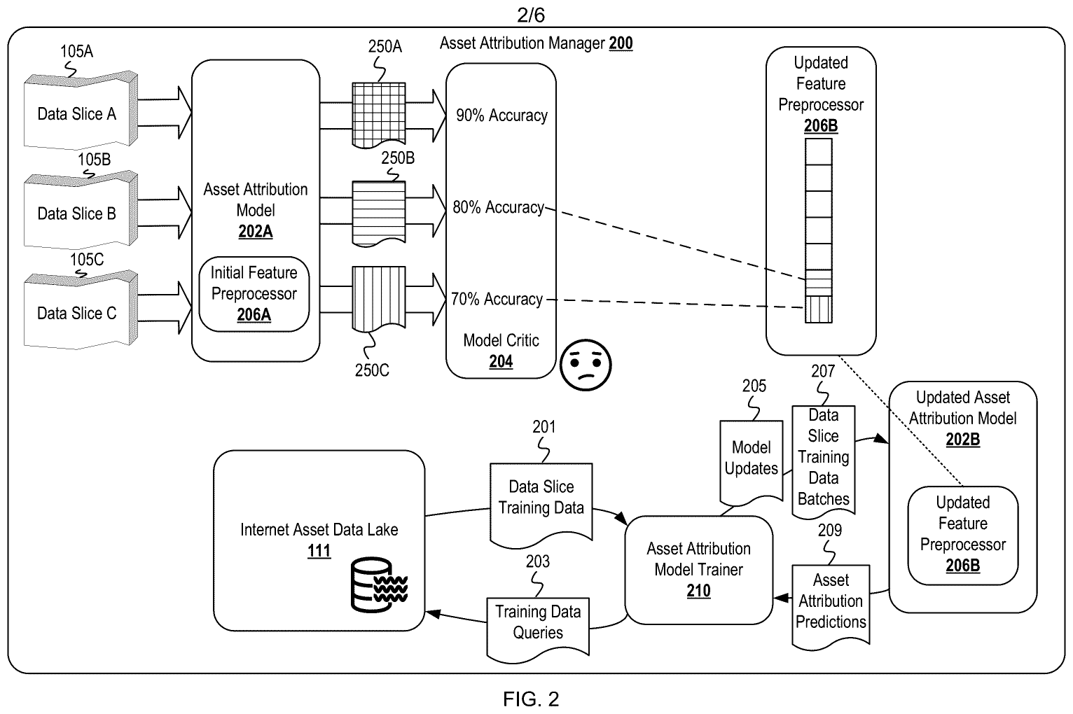

FIG. 2 is a schematic diagram of an example system for asset attribution with data slice-augmented features. An asset attribution manager 200 uses data slices 105A, 105B, and 105C to augment training data and feature generation for an asset attribution model 202A. Based on evaluating accuracy of the asset attribution model 202A on each of the data slices 105A, 105B, and 105C, the asset attribution manager 200 determines additional features to generate for data slices where the asset attribution model 202A is underperforming. An updated asset attribution model 202B configured to generate the additional features is then retrained and deployed.

The asset attribution model 202A can be any model that attributes assets to organizations. For instance, the asset attribution model 202A can be a neural network(s) that outputs probabilities of an asset being attributed to corresponding organizations, and the asset attribution model 202A can indicate attributions based on the largest probability for an asset. In some embodiments, the asset attribution model 202A contains multiple attribution sub-models. For instance, a separate model can be maintained for different regions of organizations, different types of organizations (e.g., public, private, technology areas), etc. These separate models can be used as an ensemble for asset attribution.

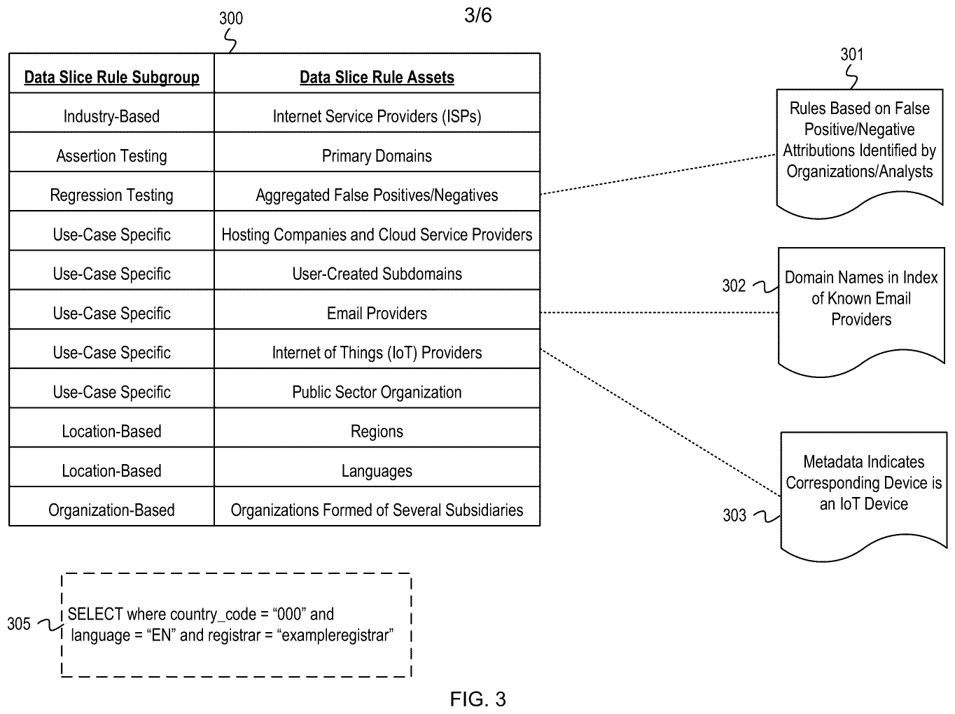

The asset attribution model 202A receives the data slices 105A, 105B, and 105C and preprocesses the data slices with an initial feature preprocessor 206A. The asset attribution model 202A then uses the data slices 105A, 105B, and 105C that have been preprocessed to generate respective predictions 250A, 250B, and 250C comprising attributions of assets in each data slice. A model critic 204 evaluates each of the predictions 250A, 250B, and 250C and determines 90% accuracy, 80% accuracy, and 70% accuracy, respectively. The model critic 204 then determines which of the corresponding data slices 105A, 105B, and 105C to use for augmenting features of the asset attribution model 202A. In this example, the model critic identifies the data slices 105B, 105C to be used in features of an updated feature preprocessor 206B. The corresponding predictions 250B, 250C have accuracies of 80% and 70% respectively, lower than the 90% accuracy of prediction 250A for data slice 105A that is not used for engineering an additional feature in the updated feature preprocessor 206B. Determining which data slices to use for feature engineering can be determined based on a threshold accuracy. The threshold accuracy can depend on the type of data slice. In some embodiments, data slices corresponding to key assets (e.g., assets that are primary domains, assets in top-N confidence scores, etc.) where the asset attribution model 202A achieves below a high or 100% accuracy are included for feature engineering as additional features in the updated feature preprocessor 206B. Features such as features in the updated feature preprocessor 206B corresponding to data slices 105B, 105C are engineered according to rules for the respective data slices by an analyst (e.g., analyst 150 in reference to FIG. 1). Examples of rules for data slices and corresponding features are given in reference to FIG. 3.

Once the data slices where the asset attribution model 202A underperforms are identified, an asset attribution model trainer 210 initializes an updated asset attribution model 202B running the updated feature preprocessor 206B. The updated asset attribution model 202B can have the same model type (e.g., neural network) as the asset attribution model 202A with an updated architecture that supports inputs having additional features comprising the features corresponding to data slices 105B and 105C. The asset attribution model trainer 210 communicates training data queries 203 to the Internet asset data lake 111. The training data queries 203 can comprise queries that yielded the data slices 105B, 105C. In some embodiments, the data slices 105A, 105B, and 105C are stored in memory on the asset attribution manager 200 (e.g., between data slice updates) for training and retraining of asset attribution models so that the asset attribution model trainer 210 can access data slices from memory rather than querying the Internet asset data lake 111. The training data queries 203 can additionally comprise queries for training data used to train the asset attribution model 202A that may not correspond to data slices. For instance, the training data can comprise generic features that capture multiple data slices, that are independent of data slices (e.g., generic features extracted from asset metadata that are engineered to improve accuracy in asset attributions across all assets and not necessarily a subset of assets corresponding to a data slice), etc. The Internet asset data lake 111 communicates data slice training data 201 to the asset attribution model trainer 210 in response to the training data queries 203. The data slice training data 201 comprises asset metadata and corresponding labels. For the data slices 105B, 105C, the labels are generated according to known labels indicating organizations with known attributions to each data slice based on domain-level expert evaluation. In some embodiments, labels can be generated based on a model consensus for several asset attribution models including the asset attribution model 202A.

The asset attribution model trainer 210 trains the updated asset attribution model 202B in a sequence of iterations through the data slice training data 201. At each iteration, the asset attribution model trainer 210 communicates data slice training data batches 207 to the updated asset attribution model 202B. Each batch in the data slice training data batches 207 is a uniformly sample subset of the data slice training data 201. The updated asset attribution model 202B preprocessing data in the data slice training data batches 207 using the updated feature preprocessor 206B and generates asset attribution prediction 209 that predict organizations attributed to each asset. The asset attribution model trainer 210 evaluates the asset attribution predictions 209 against labels for respective assets and, based on the difference between the labels and the asset attribution predictions 209, generates and communicates model updates 205 to the updated asset attribution model 202B. The model updates 205 are generated according to a loss function for the updated asset attribution model 202B evaluated on this difference. The process of predicting batches and performing model updates occurs across several epochs (i.e., iterations through the data slice training data 201) until a training termination criterion is satisfied. The training termination criterion can be completion of a threshold number of epochs, that the loss function is sufficiently low/stabilizes, that training and generalization (testing) error are sufficiently low, etc. Generalization and training error are computed according to the loss function, wherein generalization error is computed on a set of testing data in the data slice training data 201 not included in batches of testing data.

Once trained, the updated asset attribution model 202B is evaluated for accuracy against an index of data slices (not depicted). The index of data slices can be a set of data slices determined by a domain-level expert to be important enough to require satisfying threshold accuracies over respective data slices prior to deployment. The index of data slices can comprise data slices 105B, 105C that are added by the model critic 204 when evaluating model performance on the data slices. Based on poor performance of the updated asset attribution model 202B against the index of data slices, deployment can be delayed and architecture of the updated asset attribution model 202B can be updated. The updated asset attribution model 202B can be retrained and retested until it satisfies checks against the index of data slices.

FIG. 3 depicts a table of data slice rules and an example iterative data slice rule. A table 300 depicts various data slice rules labelled with corresponding data slice rule subgroups. The table 300 is copied herein:

| Data Slice Rule Subgroup | Data Slice Rule Assets |
|---|---|
| Industry-Based | Internet Service Providers (ISPs) |
| Assertion Testing | Primary Domains |
| Regression Testing | Aggregated False Positives/Negatives |
| Use-Case Specific | Hosting Companies and Cloud Service |
| | Providers |
| Use-Case Specific | User-Created Subdomains |
| Use-Case Specific | Email Providers |
| Use-Case Specific | Internet-of-Things (IoT) Providers |
| Use-Case Specific | Public Sector Organization |
| Location-Based | Regions |
| Location-Based | Languages |
| Organization-Based | Organizations Formed of Several |
| | Subsidiaries |

Example data slice rules for corresponding subgroups include example data slice rules 301, 302, and 303. Example data slice rules 301 are rules based on false positive/negative attributions identified by organizations/analysts. For instance, false positive attributions can be identified with higher frequency for assets having an “example.org” URL whereas an example organization is associated with an “example.com” URL. The corresponding rule can be that the URL has a same first token (“example”) but distinct second token (“org” and “com”) from a URL in a database of known URLs associated with organizations (e.g., primary domains). Assets identified by this rule should all have negative attributions to the example organization. Example data slice rules 302 are rules for assets corresponding to domain names in an index of known email providers. The rule is that a domain name for assets (indicated in asset metadata) is in the index of known email provider domain names, and assets in this data slice should all have positive attributions with corresponding email providers (as indicated in the index). In some embodiments, only a subset of assets will have metadata that includes URL fields (e.g., a subset of assets that were probed with HTTPS queries by a Web crawler). In these embodiments, the example data slice rules 302 apply to those assets having URL metadata that satisfy the corresponding rules. Example data slice rules 303 are rules for metadata indicating a corresponding device as an IoT device.

Features are engineered according to data slice rules such as example data slice rules 301-303. For instance, for industry-based rules, in the case of Internet service providers (ISPs), features can comprise preprocessed ISP identifiers. For primary domain rules, features can comprise tokenized/pre-processed domain names in asset metadata. For the example data slice rules 301, features can comprise encodings of URLs associated with assets. For hosting companies and cloud service providers rules, user-created subdomains rules, email provider rules, IoT provider rules, and public sector organization rules, features can comprise a lowest string distance of fields in asset metadata to an index of tokens corresponding to known hosting companies/cloud service providers, known subdomains, known email providers, known IoT providers, and known public sector organizations, respectively. For location-based data slice rules, features can comprise metadata associated with locations specified by the rules (e.g., region codes, language codes/identifiers, etc.). For organizations formed of several subsidiaries rules, features can comprise indicators of whether asset metadata fields correspond to multiple tokens in an index of tokens for known business entities (or string distances thereof).

An example iterative data slice rule 305 specifies a country code of “000”, a language of “English” within that country code, and an domain name registrar of “exampleregistrar”. Iterative rules can be converted into queries using logical operators for a corresponding querying language (e.g., the logical AND operator for SQL). Features for iterative data slice rules can comprise a concatenation of features or a subset of features for respective rules in the iteration (e.g., a concatenation of a country code field number, a language field string, and a string distance to an index of email providers), and the subset can be determined based on importance for each rule in the iteration.

Attribution models on data slices are described throughout the present disclosure as being evaluated for accuracy against known attributions for each asset in the data slice. Known attributions additionally comprise asset attributions to models with sufficiently high confidence/probability, for instance using a model consensus or when a domain-level expert knows that an overwhelming majority of assets (but not necessarily all assets) satisfying certain rules are attributed to certain organizations. In some embodiments, such as for data slice rules corresponding to organizations formed of several subsidiaries or departments, attribution models can attribute multiple organizations to a same asset. In these embodiments, the asset attribution model can determine multiple probability/confidence values corresponding to organizations that satisfy attribution criteria (e.g., when each probability/confidence value is above a threshold probability/confidence value). Examples of assets attributed to multiple organizations include assets attributed to a first organization and a second organization where the first organization hosts a server on the cloud of the second organization, assets attributed to organizations having multiple subsidiaries, and assets attributed to the government while the asset is effectively administered by multiple government agencies as sub-organizations.

In other embodiments, such as when data slices are for known false positives by the asset attribution model (e.g., as generated by a phishing attacker), data slices can have known false attributions. In these instances, when the asset attribution model is tested for accuracy, on these data slices instead of being evaluated for predicting known attributions, the asset attribution model is evaluated for not predicting false attributions (i.e., not generating a false positive attribution). Feature engineering and model updates then proceed as with other data slices having known attributions. Known attributions for each data slice correspond to characteristics that represent assets in each data slice. For instance, for the N-highest confidence assets data slice, assets within the data slice have a characteristic that they have a very likely attribution according to a predictive model. Assets in the primary domain data slice have a characteristic that they are associated with a domain name present in an open-source data set of domain names corresponding to known organizations. Each of the aforementioned data slices in table 300 comprises assets having characteristics that enable determining known attributions.

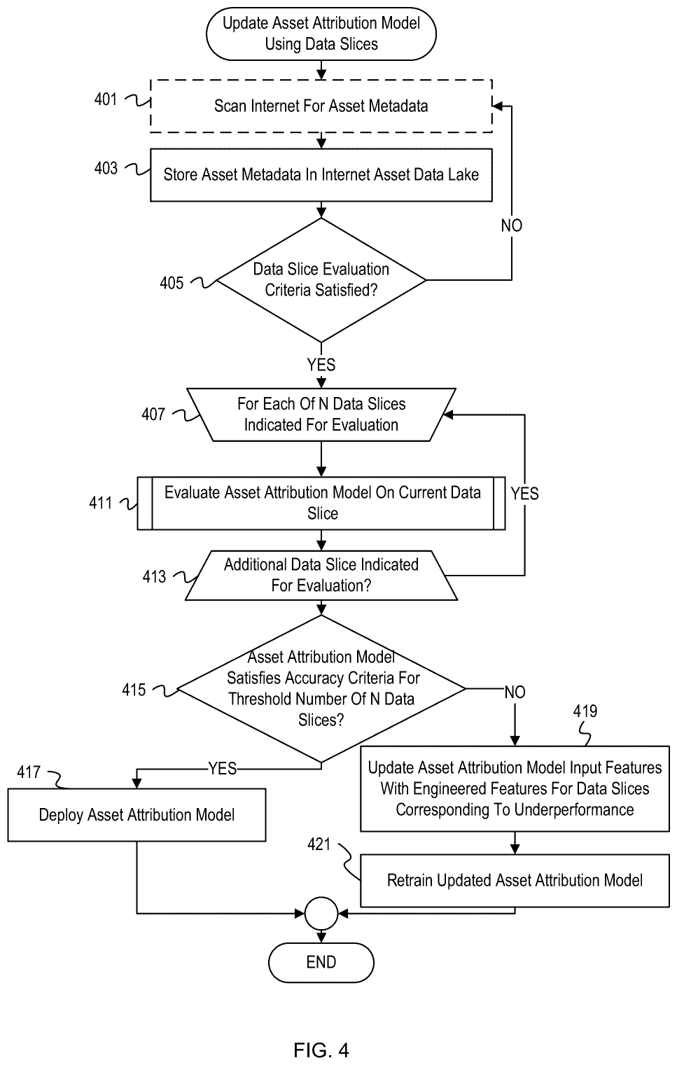

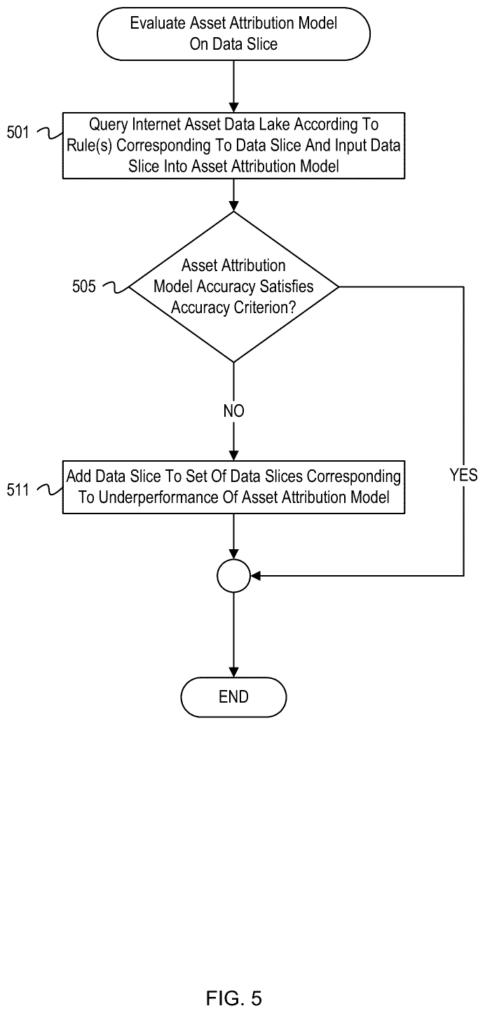

FIGS. 4-5 are flowcharts of example operations for updating asset attribution models with data slices, evaluating data slices against asset attribution models, and evaluating asset attribution models for deployment using data slices. The example operations are described with reference to an asset attribution manager for consistency with the earlier figure(s). The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 4 is a flowchart of example operations for updating an asset attribution model using data slices. At block 401, an asset attribution manager scans the Internet for asset metadata. The asset attribution manager can scan network(s) managed by one or more organizations (e.g., one or more organizations that want a map/index of all attributed assets) for open ports, closed ports, filtered/dropped/blocked ports, etc. Any applications/processes/services running on assets can be logged by the asset attribution manager as asset metadata. The asset attribution manager can additionally query URLs in a queue according to a selection policy that can include prioritizing URLs in the queue associated with metadata corresponding to known assets. This selection policy can further depend on other metrics indicating importance of URLs, and URLs can be re-queried periodically to detect changes in content. Asset metadata contained in HTTP/HTTPS responses to the URL queries can comprise IP addresses, certificate metadata, URIs, web page content, etc. The asset attribution manager can scan additional data sources such as open-source data sets for asset metadata. In some embodiments, the asset attribution manager first determines network accessible assets for network(s) managed by the one or more organizations and scans those assets determined to be network accessible for asset metadata. Block 401 is depicted with a dashed line to indicate that the network scanner scans the Internet for asset metadata and in parallel with the remaining operations until an external trigger occurs such as that an Internet asset data lake storing the asset metadata runs out of storage, an associated organization discontinues asset analysis, etc.

At block 403, the asset attribution manager or a separate parsing component stores the asset metadata in the Internet asset data lake. The asset attribution manager can extract fields from probe/scan responses. Considering HTTP/HTTPS responses as an example, the asset attribution manager can extract header fields, content (e.g., JavaScript® code, Cascading Style Sheets (CSS) code, text content, etc.), as well as additional metadata according to corresponding communication protocols such as certificate metadata according to Transport Layer Security (TLS) 1.3, port identifiers/port connectivity status, application/process identifiers, etc. The asset metadata is stored in the Internet asset data lake whose storage can further comprise metadata for organizations, indexes of known or high probability asset/organization pairs, etc. as well as additional security-related data for assets and organizations such as malware verdicts, security risk levels, etc.

At block 405, the asset attribution manager determines whether data slice evaluation criteria are satisfied. The data slice evaluation criteria can be that data slices are generated by a domain-level expert, according to an evaluation schedule for deployed asset attribution models, in response to a query by a domain-level expert, based on re-generation of data slices as asset metadata is accrued in a repository, etc. The operations at block 405 can occur simultaneously for multiple data slices, for instance when an asset attribution model is to be updated/evaluated for future deployment. If the data slice evaluation criteria are satisfied, flow proceeds to block 407. Otherwise, flow returns to block 401.

At block 407, the asset attribution manager begins iterating through N data slices indicated for evaluation. The N data slices indicated for evaluation can be based on a corresponding asset attribution model. For instance, when an asset attribution model is deployed in a particular region, then data slices with region codes outside of the specified region can be excluded. The example operations at each iteration occur at blocks 409 and 411.

At block 411 the asset attribution manager evaluates the asset attribution model on the current data slice. The operations at block 411 are depicted in greater detail in reference to FIG. 5.

At block 413, the asset attribution manager determines whether there is an additional data slice indicated for evaluation. If there is an additional data slice, flow returns to block 407. Otherwise, flow proceeds to block 415.

At block 415, the asset attribution manager determines whether the asset attribution model satisfies accuracy criteria based on the model evaluation (block 411) for a threshold number of the N data slices. In some embodiments, the asset attribution model must satisfy the accuracy criteria across all N data slices. In other embodiments, only a fraction or threshold number of accuracy criteria need to be satisfied. The asset attribution manager can require that all high-importance data slices have accuracy criteria satisfied while only a fraction or threshold of low-importance data slices have accuracy criteria satisfied. If the threshold number of accuracy criteria are satisfied for the N data slices flow proceeds to block 417. Otherwise, flow proceeds to block 419.

At block 417, the asset attribution manager deploys the asset attribution model. The asset attribution manager can implement the asset attribution model in code at a corresponding device and/or in the cloud as a Software-as-a-Service (SaaS) product. In some embodiments, the asset attribution model predicts assets and determines known assets belonging to an organization (e.g., an organization subscribing to the SaaS product). The organization then uses attributed assets to evaluate security risks/potential entry points for malicious attacks corresponding to untracked/deprecated assets that are exposed to the Internet. In other embodiments, the asset attribution manager generates a graph structure representing asset/organization pairs that it presents to a graphical user interface (GUI) of a user of the SaaS product. Subsequent to deployment, the asset attribution manager can reiterate the operations depicted in FIG. 4 to reevaluate the asset attribution model as asset metadata is continuously accumulated in the Internet asset data lake.

At block 419, the asset attribution manager updates input features for the asset attribution model with engineered features for data slices corresponding to underperformance. Underperformance indicates that the asset attribution model fails corresponding accuracy criteria for respective data slices. The added features can be preprocessed metadata fields corresponding to rules for the data slices. For instance, when the rules associate assets with organizations labeled by primary domains, then the additional features can comprise a field corresponding to primary domain information (e.g., extracting according to syntax of URL(s) for the asset) preprocessed as a numerical feature (e.g., using word2vec). The additional input features can be determined by a domain-level expert and an amount of additional input features can be according to a weight indicating a degree of underperformance for each respective data slice (e.g., data slices where the asset attribution model severely underperforms result in more additional input features) as well as importance/security risk for corresponding rule(s). The asset attribution manager can further update architecture of the asset attribution model so that it can receive the additional inputs. For instance, for a neural network, the asset attribution manager can add additional input layers and can increase the size of internal layers.

In addition to updating architecture for the asset attribution model to facilitate additional input features corresponding to underperforming data slices, the asset attribution manager can update additional aspects of the asset attribution model to improve performance. For instance, the asset attribution manager can identify deficiencies in the type of asset attribution model (e.g., a neural network) and can replace the model with a more effective model type (e.g., gradient boosting applied to decision trees) that has known improved performance. Additionally, the asset manager can update internal parameters, hyperparameters, and training methods (e.g., number of epochs, convergence criteria, gradient descent algorithms, etc.) of the asset attribution model to improve performance. Accordingly, rather than updating an input layer or internal layers for model types distinct from neural networks, the asset attribution manager can update an input component that is configured, based on model type, to process inputs according to the number of features that can be modified according to data slices.

At block 421, the asset attribution manager retrains the updated asset attribution model. The asset attribution manager can query the Internet asset data lake for training data, can divide the training data into training and testing data (e.g., according to a predetermined ratio by uniformly sampling the training data), and can train the asset attribution model until training termination criteria are satisfied. The training and testing data includes, in addition to training and testing data used for the asset attribution model pre-update, additional training data comprising the engineered features for data slices (i.e., assets in these data slices) where the asset attribution model was underperforming. The training termination criteria can be that a threshold number of epochs has elapsed, that training error/generalization error are sufficiently small, that predictions are converging across training iterations, etc.

FIG. 5 is a flowchart of example operations for evaluating an asset attribution model on a data slice. At block 501, an asset attribution manager queries an Internet asset data lake according to rule(s) corresponding to a data slice and inputs the data slice into an asset attribution model. The data slice rules interface can comprise a parser that converts the rule(s) into a query formatted according to an API for the Internet asset data lake. In other embodiments, the query can be generated by a domain-level expert that determined the corresponding rule(s). The Internet asset data lake returns the data slice in response to the query and the data slice rules interface (or, in some embodiments, an asset attribution manager or other component) inputs the data slice into the asset attribution model. In some embodiments, the Internet asset data lake can store the data slice returned by the Internet asset data lake for future use until the Internet asset data lake is updated with additional asset metadata from ongoing scanning of network accessible assets.

At block 505, the asset attribution manager determines whether the asset attribution model accuracy fails an accuracy criterion. The accuracy is determined based on a comparison of known organization labels for assets in the data slice to organization predictions made by the asset attribution model. The accuracy criterion can depend on the type/importance of the data slice (e.g., an important data slice has an accuracy criterion that specifies a higher accuracy threshold percentage than an accuracy criterion for a less important data slice). Data slices that have iterative rules can have accuracy criteria that depend on one or more of the iterative rules. For instance, the accuracy criterion can be the highest accuracy percentage threshold across the iterative rules. For data slices with known false attributions (e.g., based on false positive), the accuracy can be determined based on whether a number of threshold predictions by the asset attribution model are not the false attributions (i.e., the asset attribution model does not recreate the false positives). To exemplify, for a data slice specifying assets having a URL metadata field that is on (or in proximity to) a list of known email providers then the evaluation criterion is that each asset should be correctly predicted (or, in some embodiments, a threshold percentage of assets) with the corresponding email provider indicated in the header. For data slices of top-N highest confidence assets (according to a confidence score generated by a confidence prediction model), assets can have labels according to the most confident organizations, and the accuracy criteria can be that all assets are correctly attributed. The accuracy criteria can depend on types of data slices and data slices with higher importance (as determined, e.g., by a domain level expert) can have accuracy criteria requiring a higher percentage of correct attributions by the asset attribution model. If the accuracy criterion is not satisfied, flow proceeds to block 511. Otherwise, the operations in FIG. 5 are complete.

At block 511, the asset attribution manager adds the data slice to a set of data slices corresponding to underperformance of the asset attribution model. The data slice can be stored along with a weight that indicates a degree to which the data slice did not satisfy the accuracy criterion (e.g., a percentage difference between the accuracy of the asset attribution model and a threshold accuracy percentage). The data slices and corresponding weights are stored for future updating and retraining of the asset attribution model.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in block 501 can occur in parallel across data slices to retrieve asset metadata for respective assets in each data slice. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

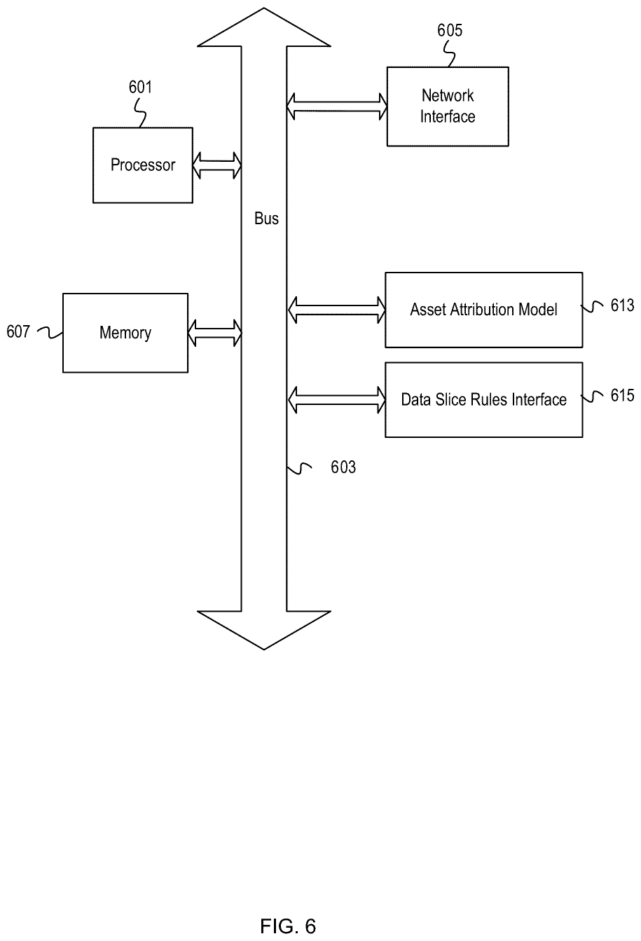

FIG. 6 depicts an example computer system with an asset attribution model and a data slice rules interface. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes an asset attribution model 613 and a data slice rules interface 615. The asset attribution model 613 can attribute assets to organizations based on metadata for assets in the Internet Asset data lake with asset metadata. The data slice rules interface 615 can query the data lake according to rules for respective data slices with known attributed organizations. The asset attribution model 613 can be evaluated and updated along data slices for improved model performance, as described variously above. Any one of the previously described functionalities may be partially (or entirely) implemented in hardware and/or on the processor 601. For example, the functionality may be implemented with an application specific integrated circuit, in logic implement ted in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601. While depicted for a single computer system, any of the described functionalities in FIG. 6 may be implemented on multiple computer systems in a distributed computing environment, a cloud computing environment, or a serverless computing environment and the processor 601 and memory 607 can be distributed as multiple processors and multiple memory components across any of the aforementioned computing environments.

While the aspects of the disclosure are described with reference to various implementations and exploitations, it will be understood that these aspects are illustrative and that the scope of the claims is not limited to them. In general, techniques for feature engineering and model retraining using data slices of assets with known attributions as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

1. A method comprising:
selecting a first subset of a plurality of assets based, at least in part, on a first rule of one or more rules for selecting from the plurality of assets based on metadata of the plurality of assets, wherein the one or more rules correspond to respective subsets of the plurality of assets including the first subset of the plurality of assets with known attributions to one or more organizations in a plurality of organizations;
inputting metadata for the first subset of the plurality of assets into an asset attribution model to determine an accuracy of the asset attribution model based, at least in part, on a first organization in the plurality of organizations with known attribution to the first subset of the plurality of assets; and
based on a determination that accuracy of the asset attribution model on the first subset of the plurality of assets fails an accuracy criterion, updating architecture for the asset attribution model.

2. The method of claim 1, wherein updating architecture for the asset attribution model comprises,
engineering one or more features of the metadata of the plurality of assets based, at least in part, on the first rule for selecting from the plurality of assets; and
configuring an input component of the asset attribution model to process the one or more features.

3. The method of claim 1, wherein the one or more rules for selecting from the plurality of assets based on metadata of the plurality of assets comprise rules for at least one of assertion testing-based, regression testing-based, location-based, and organization-based metadata in the metadata of the plurality of assets.

4. The method of claim 1, wherein selecting the first subset of the plurality of assets based, at least in part, on the first rule comprises querying a repository for the first subset of the plurality of assets, wherein the query is generated based, at least in part, on logic for metadata of the plurality of assets expressed by the first rule.

5. The method of claim 1, further comprising, based on the determination that the accuracy of the asset attribution model on the first subset of the plurality of assets fails the accuracy criterion, retraining the asset attribution model with the updated architecture on asset metadata.

6. The method of claim 1, wherein the accuracy criterion comprises a determination of whether the asset attribution model correctly predicts a threshold number of assets of the first subset of the plurality of assets according to known attributions of the first subset of the plurality of assets to the one or more organizations.

7. The method of claim 1, further comprising, based on the determination that accuracy of the asset attribution model on the first subset of the plurality of assets fails the accuracy criterion, updating at least one of a type of the asset attribution model, parameters of the asset attribution model, hyperparameters of the asset attribution model, and a training method for the asset attribution model.

8. The method of claim 1, further comprising,
selecting one or more subsets of the plurality of assets based, at least in part, on respective rules in the one or more rules; and
based on a determination that the asset attribution model satisfies accuracy criteria for corresponding subsets of the one or more subsets, deploying the asset attribution model for asset attribution.

9. A non-transitory, computer-readable medium having program code stored thereon to perform operations comprising:
evaluating an asset attribution model for accuracy in predicting attributed organizations on metadata for a first subset of a plurality of assets, wherein the first subset of the plurality of assets is based, at least in part, on one or more rules for metadata of the plurality of assets, wherein the accuracy in predicting attributed organizations is based on known attributed organizations for assets having metadata that satisfies the one or more rules;
engineering one or more features for metadata of the plurality of assets based, at least in part, on the one or more rules for metadata of the plurality of assets;
updating architecture of the asset attribution model to receive the one or more features as additional inputs; and
retraining the asset attribution model with the updated architecture.

10. The computer-readable medium of claim 9, further comprising program code to select the first subset of the plurality of assets from the plurality of assets based, at least in part, on a first rule of the one or more rules for metadata of the plurality of assets.

11. The computer-readable medium of claim 9, further comprising program code to determine whether accuracy of the asset attribution model in predicting attributed organizations satisfies an accuracy criterion.

12. The computer-readable medium of claim 11, wherein the accuracy criterion comprises a determination that a number of correct predictions by the asset attribution model on metadata for the first subset of the plurality of assets is above a threshold number of correct predictions, wherein correct predictions are according to known attributed organizations for assets in the first subset of the plurality of assets.

13. The computer-readable medium of claim 11, further comprising program code to update at least one of a type of the asset attribution model, parameters of the asset attribution model, hyperparameters of the asset attribution model, and a training method for the asset attribution model based, at least in part, on the asset attribution model failing the accuracy criterion.

14. The computer-readable medium of claim 9, further comprising program code to,
select one or more subsets of the plurality of assets from the plurality of assets at least including the first subset of the plurality of assets based, at least in part, on the one or more rules for metadata of the plurality of assets;
evaluate the asset attribution model for accuracy in predicting attributed organizations on metadata for the one or more subsets of the plurality of assets; and
based on a determination that accuracy of the asset attribution model in predicting attributed organizations on metadata for the one or more subsets of the plurality of assets satisfies respective accuracy criteria, deploying the asset attribution model.

15. An apparatus comprising:
a processor; and
a computer-readable medium having instructions stored thereon that are executable by the processor to cause the apparatus to,
for each data slicing rule of a plurality of data slicing rules that correspond to different characteristics of network accessible assets, obtain a data slice according to the data slicing rule from a repository of data about a plurality of network accessible assets with known attributions to one or more organizations of a plurality of organizations;
obtain organization attribution predictions from a machine learning model based, at least in part, on the obtained data slices; and
evaluate accuracy of the machine learning model with the known attributions corresponding to the organization attribution predictions.

16. The apparatus of claim 15, wherein the computer-readable medium further has stored thereon instructions executable by the processor to cause the apparatus to update architecture of the machine learning model based on a determination that accuracy of the machine learning model for at least a first of the obtained data slices fails an accuracy criterion.

17. The apparatus of claim 16, wherein the instructions executable by the processor to cause the apparatus to update architecture of the machine learning model comprise instructions to,
identify a first data slicing rule of the plurality of data slicing rules that corresponds to the first data slice;
engineer one or more features from the data about the plurality of network accessible assets based, at least in part, on the first data slicing rule; and
configure an internal component of the machine learning model to process the one or more features.

18. The apparatus of claim 16, wherein the computer-readable medium further has stored thereon instructions executable by the processor to cause the apparatus to update at least one of a type of the machine learning model, parameters of the machine learning model, hyperparameters of the machine learning model, and a training method for the machine learning model based, at least in part, on the determination that accuracy of the machine learning model for at least a first of the obtained data slices fails the accuracy criterion.

19. The apparatus of claim 15, wherein the plurality of data slicing rules comprises rules for obtaining at least one of assertion testing-based data slices, regression testing-based data slices, location-based data slices, and organization-based data slices.

20. The apparatus of claim 15, wherein the computer-readable medium further has stored thereon instructions executable by the processor to cause the apparatus to update the repository with additional data about network accessible assets with additional data obtained from ongoing network scanning.
